(19) United States
(12) Patent Application Publication
(10) Pub. No.: US 2021/0350202 A1
(43) Pub. Date: Nov. 11, 2021

(54) METHODS AND SYSTEMS OF AUTOMATIC CREATION OF USER PERSONAS

(71) Applicants: SUJIT THOMAS ZACHARIAH, dublin, CA (US); GOLAK BIHARI SARANGI, bangalore (IN)

(72) Inventors: SUJIT THOMAS ZACHARIAH, dublin, CA (US); GOLAK BIHARI SARANGI, bangalore (IN)

(21) Appl. No.: 17/195,633

(22) Filed: Mar. 8, 2021

Related U.S. Application Data
(60) Provisional application No. 62/986,747, filed on Mar. 8, 2020.

(51) Int. Cl. G06N 3/00; G06N 20/00; G06F 21/62

(52) U.S. Cl. CPC G06N 3/006; G06F 21/6254; G06N 20/00

(57) ABSTRACT

A computerized method for managing an artificially-intelligent platform to generate personas automatically from digital data includes the step of obtaining an analytics data set. The method includes the step of augmenting the analytics data set with additional context information provided by augmentation data, wherein the augmentation data comprises specified a set of external data sources and data models. The method includes the step of determining, with a specified machine learning algorithm, a set of behavioral insights from the augmented analytics data set. The method includes the step of automatically grouping a set of users of a web-application or web site based on their behavior, demographics, history of transactions, and psychographics. The method includes the step of generating a persona for each of the segment associated with a user of the set of user, wherein a segment is a group based on a user behavior, a user demographic, a user transactional history, a user psychographic attribute.

### CLAIM OF PRIORITY AND CROSS-REFERENCE TO RELATED APPLICATIONS

This application claims priority to U.S. Provisional Patent Application No. 62/986,747, filed on Mar. 8, 2020 and titled METHODS AND SYSTEMS OF AUTOMATIC CREATION OF USER PERSONAS. This application is hereby incorporated by reference in its entirety.

### BACKGROUND

Personas are currently created primarily by qualitative methods. Qualitative methods can be based on user research. This can involve interviewing or surveying users, prospects and/or customers. While such methods provide depth of insights such as motivations and challenges/pain points, they are neither easily scalable to millions of data points nor amenable to frequent updates. As a result, persona related tools today are primarily limited to templates or visualization tools that rely on inputs from the user surveys/interviews. Accordingly, improvements to the automatic creation of user personas are desired.

A computerized method for managing an artificially-intelligent platform to generate personas automatically from digital data includes the step of obtaining an analytics data set. The method includes the step of augmenting the analytics data set with additional context information provided by augmentation data, wherein the augmentation data comprises specified a set of external data sources and data models. The method includes the step of determining, with a specified machine learning algorithm, a set of behavioral insights from the augmented analytics data set. The method includes the step of automatically grouping a set of users of a web-application or web site based on their behavior, demographics, history of transactions, and psychographics. The method includes the step of generating a persona for each of the segment associated with a user of the set of user, wherein a segment is a group based on a user behavior, a user demographic, a user transactional history, a user psychographic attribute.

### BRIEF DESCRIPTION OF THE DRAWINGS

FIG. 1 illustrates an example system for automatic creation of user personas, according to some embodiments.

FIG. 2 illustrates an example screenshot of a sample of a segment specific persona, according to some embodiments.

FIG. 3 illustrates an example set of screenshots of an AI generated persona, according to some embodiments.

FIG. 4 illustrates a set of attributes analyzed and displayed when generating personas, according to some embodiments.

FIG. 5 illustrates an example process for managing an AI platform to generate personas automatically from digital data, according to some embodiments.

FIG. 6 illustrates an example system for generating personas automatically from digital data, according to some embodiments.

FIG. 7 is a block diagram of a sample computing environment that can be utilized to implement various embodiments.

FIG. 8 illustrates an example process for using AI/ML techniques to generate artificial personas, according to some embodiments.

The Figures described above are a representative set and are not an exhaustive with respect to embodying the invention.

### DESCRIPTION

Disclosed are a system, method, and article of automatic creation of user personas. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Density-based spatial clustering of applications with noise (DBSCAN) is a data clustering algorithm. It is a density-based clustering non-parametric algorithm: given a set of points in some space, it groups together points that are tightly packed together (e.g. points with many nearby neighbors), marking as outliers points that lie alone in low-density regions (e.g. whose nearest neighbors are too far away).

Generative Adversarial Networks (GAN) is a class of machine learning frameworks designed by Ian Goodfellow and his colleagues in 2014. Two neural networks contest with each other in a game (in the form of a zero-sum game, where one agent's gain is another agent's loss). Given a training set, this technique learns to generate new data with the same statistics as the training set. For example, a GAN trained on photographs can generate new photographs that look at least superficially authentic to human observers, having many realistic characteristics. Though originally proposed as a form of generative model for unsupervised learning, GANs have also proven useful for semi-supervised learning, fully supervised learning, and reinforcement learning. The core idea of a GAN is based on the “indirect” training through the discriminator, which itself is also being updated dynamically. This basically means that the generator is not trained to minimize the distance to a specific image, but rather to fool the discriminator. This enables the model to learn in an unsupervised manner. In one example, a GAN can be used for image generation.

K-means clustering is a method of vector quantization, originally from signal processing, that aims to partition n observations into k clusters in which each observation belongs to the cluster with the nearest mean (e.g. cluster centers or cluster centroid), serving as a prototype of the cluster. This results in a partitioning of the data space into Voronoi cells. K-means clustering minimizes within-cluster variances (e.g. squared Euclidean distances), but not regular Euclidean distances: the mean optimizes squared errors, whereas only the geometric median minimizes Euclidean distances. Euclidean solutions can be found using k-medians and k-medoids.

Linear regression is a linear approach to modelling the relationship between a scalar response and one or more explanatory variables (e.g. dependent and independent variables).

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Psychographics is a qualitative methodology used to describe traits of humans on psychological attributes.

Regression analysis is a set of statistical processes for estimating the relationships between a dependent variable (e.g. outcome variable) and one or more independent variables (often called predictors, covariates, features, etc.). Regression analysis includes linear regression, in which one finds the line (or a more complex linear combination) that most closely fits the data according to a specific mathematical criterion. The method of ordinary least squares computes the unique line (or hyperplane) that minimizes the sum of squared differences between the true data and that line (or hyperplane).

Example Methods

Personas can be user/buyer personas. These can be fictional representations or composite views of audience segments based on various factors. Personas can include inputs from customer demographics, behaviors, motivations, goals, data of existing customers, data from competitor's customers, research, etc.

Some of the functional roles and use-cases that data driven personas can be used for, include, inter alia: designers (e.g. design/UX); product managers/developers (user stories); digital marketers/agencies (e.g. automation/optimization); content marketers (e.g. content strategy); sales/e-commerce (e.g. buyer persona); recruiters (e.g. candidate persona); customer service (e.g. customer support persona); etc. More specifically, in marketing, personas can be used to improve a variety of use-cases, such as, inter alia: targeting, recommendations, personalization/one on one engagement, prediction/forecasting, etc.

Apart from marketing and design/product management functions, personas can also be used by other functions such as human resources and staffing/recruiting functions. Candidate/employee personas, based on matching workforce requirements/needs with candidate/employee skills, help find better candidates and improve allocation of resources to roles/functions/projects.

Accordingly, present quantitative methods can enable frequent updates and data inputs at scale as complementary means to generating user/buyer personas. These can include ‘live’ personas that are updated frequently and are needed to understand shifts in consumer behavior, their evolving needs over time and detect anomalies/changes as they happen. Quantitative methods can enable rapid generation and frequent updates of personas and use data at scale. The resulting humanized data can be used answer various questions (e.g. How many types of users (user segments) does my website/app have?; How would you describe who they are?; What are the differences between users across segments?; etc.). Machine learning can be used to obtain industry specific insights using deep libraries of domain specific intent.

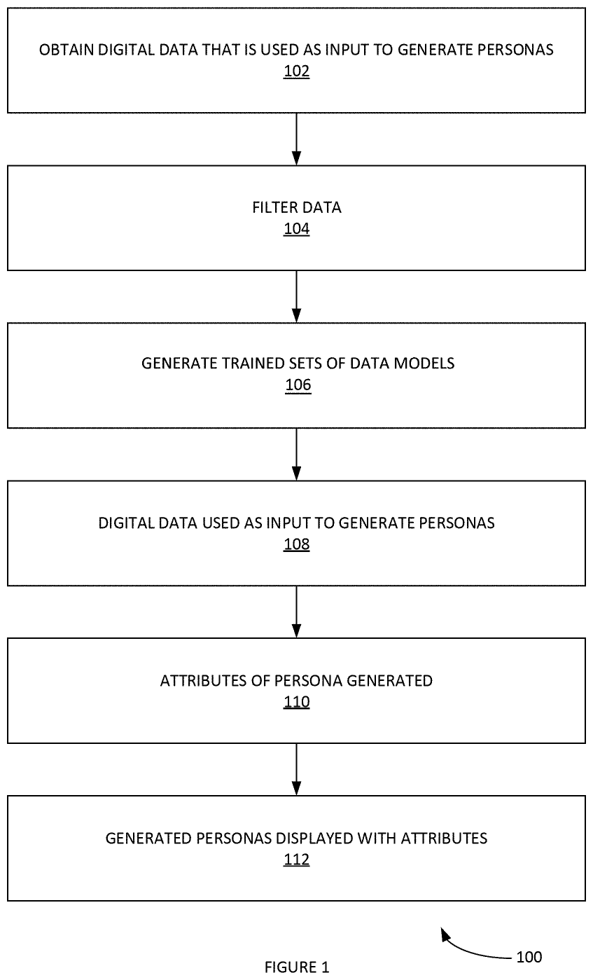

FIG. 1 illustrates an example system 100 for automatic creation of user personas, according to some embodiments. Process 100 can be used to automatically generate user/buyer personas for a given website/mobile application, business or industry from digital data.

In step 102, process 100 can obtain digital data, including textual content, that is used as input to generate personas. By way of example, process 100 can obtain the following digital data, inter alia: web/mobile analytics tools capturing first-party traffic data (e.g. Google Analytics, Adobe Analytics, Mixpanel, Heap Analytics, Amplitude, etc.); third-party tools that provide competitor intelligence and/or client panel data (e.g. SimilarWeb, Amazon Alexa Internet, etc.): page/account analytics from social networks (e.g. Facebook, Twitter, Linkedin, Instagram, Pinterest, Medium, TikTok, etc.); seller analytics data from marketplaces (e.g. Amazon, etc.); analytics data from website builder platforms (e.g. Wordpress, Wix, Squarespace, etc.); performance analytics from advertising networks (e.g. Google, Facebook, Linkedin, etc.); search console analytics from search engines (e.g. Google, Bing, etc.); analytics data from e-commerce platforms (e.g. Shopify, Magento, Woocommerce, etc.); customer relationship management, customer support, order tracking and lead tracking tools (e.g. Salesforce, Zendesk, Zoho, Freshdesk, etc.); marketing analytics from email/marketing automation platforms (e.g. Hubspot, Marketo, Klaviyo, etc.); an application store analytics dataset (e.g. Google Play Store, Apple App Store, Samsung Galaxy Apps, Amazon Appstore, etc.); survey/interview/focus groups/feedback/research data collected via platforms (e.g. Google Surveys, SurveyMonkey, Cint, etc.); transcripts and leads data from chat tools (e.g. Intercom, Drift, etc.); logs/analytics data from emails, calls, SMS, notifications, etc. (e.g. Twilio, Mailchimp, ConstantContact, Sendgrid); publicly visible news, reviews, mentions, discussions and engagement activity on social media, news sources, blogs, forums and online communities, etc.

Additionally, competitor personas can be generated using competitor intelligence data. A competitor persona can be a semi-fictional representation of the customers/users of a competitor business. These can be based on market research and real data about the competitor's customers/users.

Source data can be provided to a persona-generating platform either via ongoing programmatic access (e.g. using API/feed integrations, etc.) and/or via manual uploads. Data is typically provided as dimensions and metrics and may include historical/projected data.

In step 104, process 100 can filter data. Step 104 can be implemented on an optional basis. Data can be filtered by one of a set of specified attributes to create narrower segments. Segments include, inter alia: brand/product/service; country/region/city/locality/postal code; channel/source/medium; age(s)/screen(s)/content; device type/make/model; etc.

In step 106, process 100 can generate sets of trained data models. These can be derived from correlations between content/actions and/or dimensions/metrics.

In step 108, process 100 can use the digital data and the trained data models to generate personas.

In step 110, process 100 can generate the attributes of the persona. Process 100 can display the generated personas with these attributes in step 112. Details of the generated personas can be rendered/accessed/distributed as one or more web pages (e.g. HTML/CSS), images (e.g. JPEG/PNG), text documents (e.g. plain text/PDF), videos (e.g. MP4), or via API/technical integrations (e.g. XML/JSON).

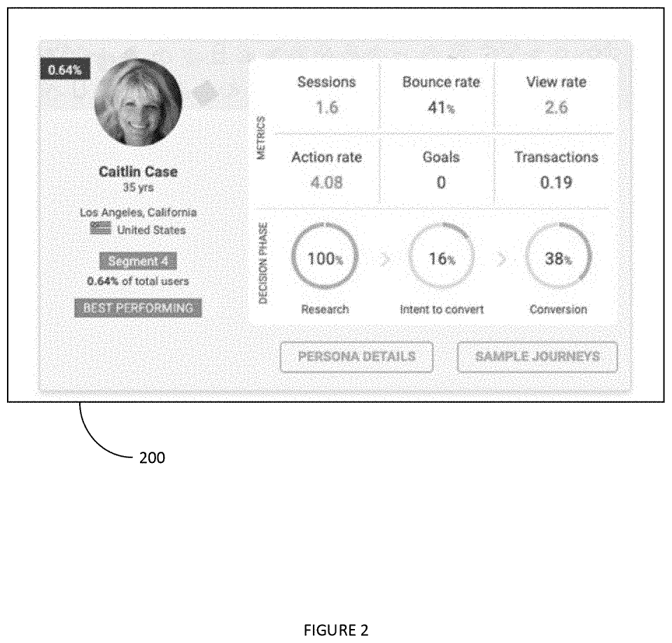

FIG. 2 illustrates an example screenshot 200 of a sample of a segment specific persona, according to some embodiments. It is noted that a single persona can be generated for an entire audience (e.g. without segmentation). Alternately, personas can be generated segment wise with, inter alia: manual segmentation using one or dimensions and/or automatic segmentation (e.g. using behavioral, demographic, transactional and/or psychographic segmentation, etc.). Example screenshot 200 shows a sample of a segment specific persona (e.g. summary view) generated process 100 and/or the various systems provided infra.

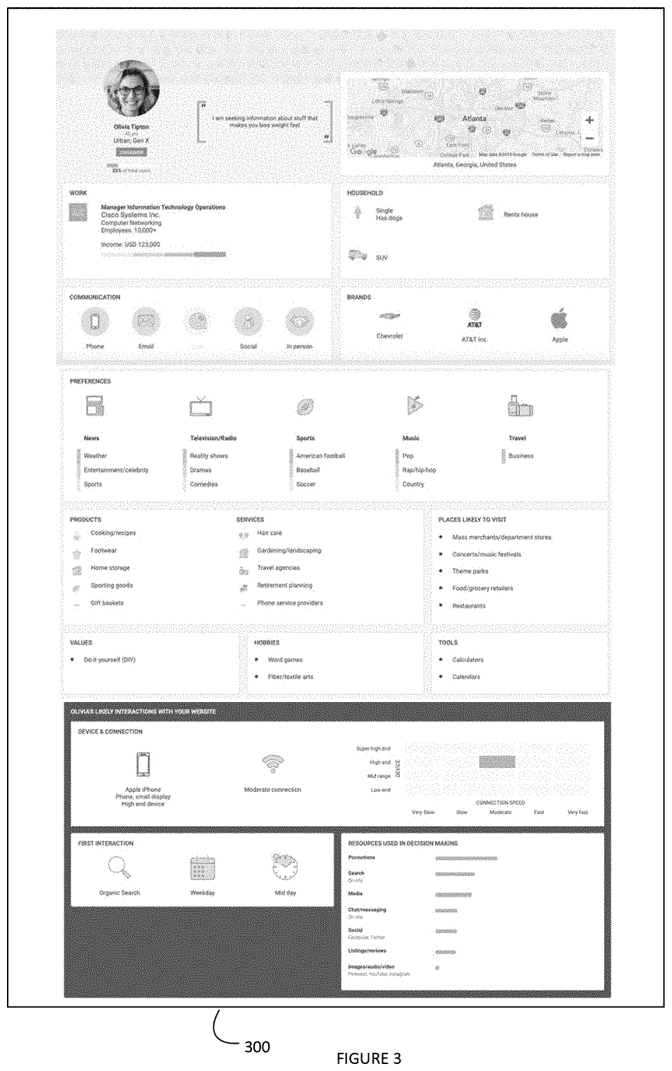

FIG. 3 illustrates an example set of screenshots 300 of an AI generated, data-driven persona, according to some embodiments. A detailed view with attributes is shown. Attributes of the example generated persona of screenshots 300 can be inferred and/or be directly abstracted based on data. Attributes generated and displayed can include, inter alia: name; profile avatar/picture/photo; demographics (e.g. age, gender, marketing generation (e.g. millennial); location (e.g. country/region/city/locality, urbanicity (e.g. semi-urban), territory (e.g. located in same city as the business)); type: business-to-consumer (B2C), business-to-business-to-consumer (B2B2C), direct to consumer (D2C), business-to-business (B2B), business-to-government (B2G); quote/job to be done; work (e.g. company (employee count)/industry, job function/job title, income, etc.); household (e.g. marital status, family/pets, home ownership status, automotive ownership status, etc.); communication preferences (e.g. phone, email, chat, social, in-person); brand affinity; preferences (e.g. news, television/radio, sports, music, travel, entertainment, food, movies, etc.); goals, needs, pains, challenges, emotional triggers; personality traits; products and/or services likely to be purchased; places likely to visit; values; hobbies; tools used; likely interactions (acquisition, repeat) (e.g. device, connection, channel, time/day, etc.); resources likely influential in decision making; topics of interest; cost of acquisition via campaigns; etc.

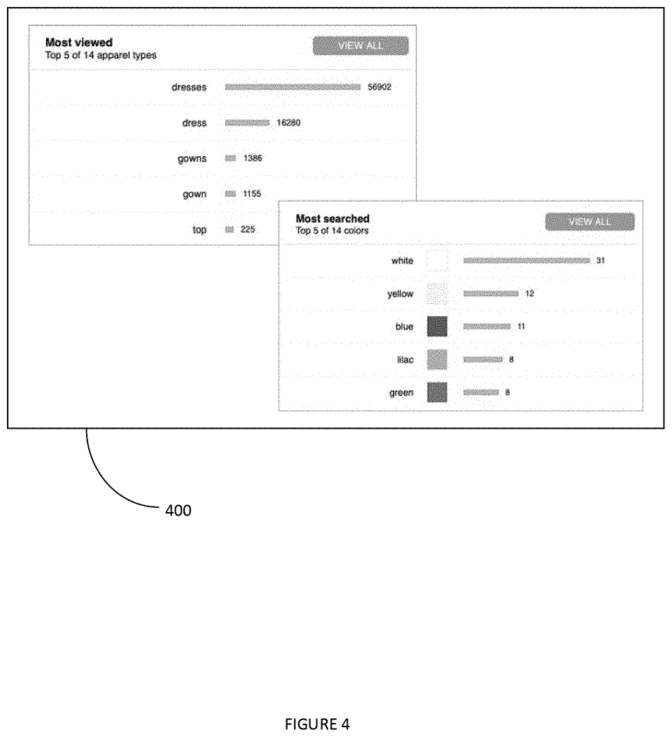

FIG. 4 illustrates a set of attributes analyzed and displayed when generating personas, according to some embodiments. The set of attributes can include industry specific insights based on views/searches or other interactions for inferred attributes such as apparel type and color for apparel and fashion industry. Sample set of industry specific insights (Apparel and Fashion). Personas can be generated from digital data across all countries/geographies, languages, and industries, including, inter alia: B2B (business-to-business) (e.g. information technology and services, human resources, marketing and advertising, SaaS, etc.); B2C (business-to-consumer) (e.g. apparel and fashion, automotive, banking, and financial services, consumer goods, education, health, wellness and fitness, hospitality, leisure, travel and tourism, real estate, retail, etc.); etc.

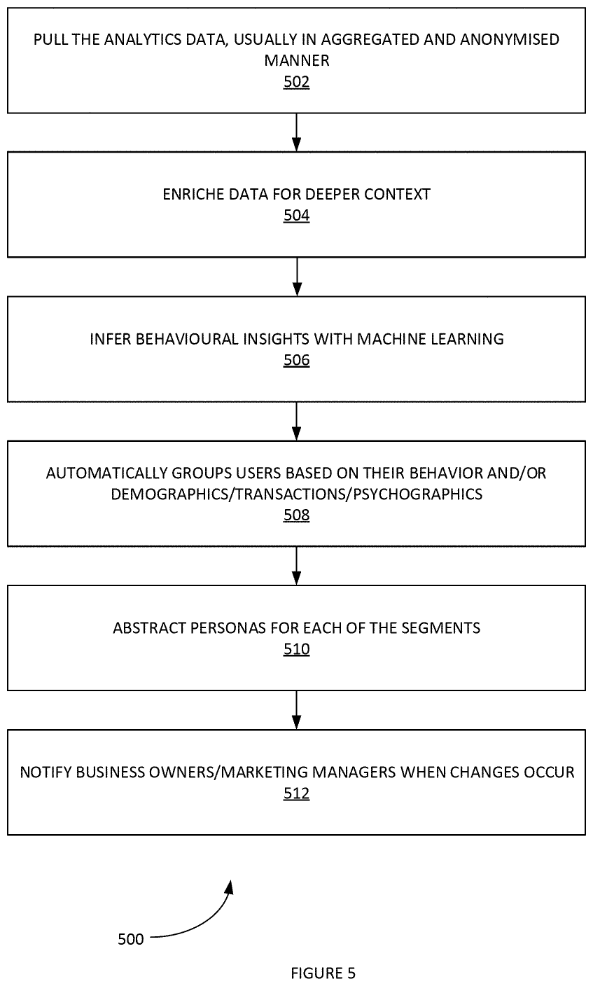

FIG. 5 illustrates an example process 500 for managing an AI platform to generate personas automatically from digital data, according to some embodiments. In step 502, process 500 pulls the analytics data. This can be implemented in aggregated and anonymized manner.

In step 504, process 500 enriches data for deeper context. Process 500 can augment data for deeper user context. Augmentation can include including external/generated data sources/models. This can include, inter alia: query analysis, Internet service provider, connection speed, device features, display size, etc. The following analysis can be performed, inter alia: content analysis, action/event analysis, goals, transactions, etc. These can be based on, inter alia: urbanicity, territory, climate zone, etc. The periodicity can be, inter alia: weekend/weekday, part of day, holiday/occasion, weather, Season, etc. Augmentation can include identity information such as, inter alia: organization, industry, language, translation, industry specific insights, etc.

In step 506, process 500 unearths behavioral insights with machine learning. Example of machine learning processes and implementations are provided infra. These can be adapted for process 500. Inferred insights using machine learning may include, inter alia: intent (e.g. inferred from website, questionnaire, etc.); decision phase (e.g. based on research, intent to convert (online/offline), conversion, etc.); etc.

A conversion occurs when a visitor to the website/mobile application completes a desired action (e.g. as signing up for newsletter, social media share, filling out a form or making a purchase, etc.). A decision phase represents a stage that a customer goes through leading up to a conversion.

In step 508, process 500 automatically groups users based on their behavior and/or demographics/transactions/psychographics. In step 510, process 500 abstracts personas for each of the segments. Process 500 can segment groups based on behavioral/demographic/transactional/psychographic attributes used for automated segmentation. These can include, inter alia: engagement, context, intent, actions, age, gender, language(s), job function, industry, transactions/revenues, product/service/category affinity based on purchase history, lifestyle, values, hobbies, personality traits, social class, interests, etc. These can include various outcomes (e.g. conversions, decision phase, etc.).

In step 512, process 500 notifies business owners/marketing managers when changes occur. Process 500 can humanize the abstractions for human assimilation and follow-up (e.g. segment-wise). These can include, inter alia: personas, user flows, funnels, sample user/organizational journeys, etc. It is noted that one or more of the steps of process 500 can be skipped in various example embodiments.

It is noted that, in one example, process 500 can include a step for visitor group identification before generating personas, based on profile, intent and behavior. Process 500 can automatically classify users into one or more of the following groups, inter alia: business prospects, job seekers/recruiters, investors, partners/competitors, press, service providers, blog readers, government entities, etc.

Process 500 can utilize machine learning methods. Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

Example Systems

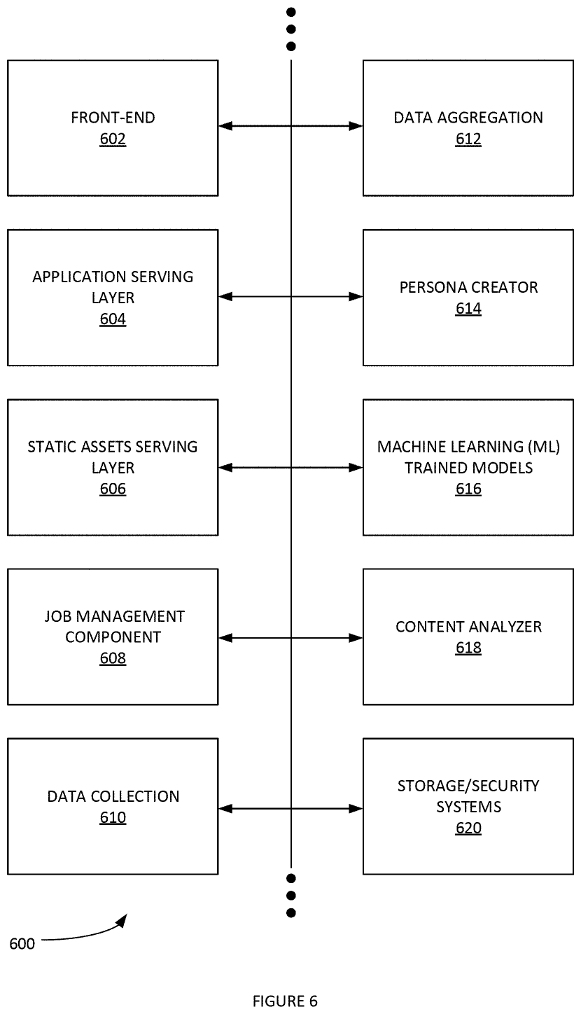

FIG. 6 illustrates an example system 600 for generating personas automatically from digital data, according to some embodiments. System 600 can implement the systems and processes provided in FIGS. 1-5. System 600 can be implemented by exemplary computing system 700 and/or various cloud-computing platform.

Front-end system 602 can provide various webpages/web applications. Front-end system 602 can be implemented with various popular web browsers (e.g. Google Chrome, Apple Safari, Mozilla Firefox, and Microsoft Edge). Front-end system 602 can provide a single page and/or multiple page web or mobile applications. In one example, Front-end system 602 can utilize JavaScript to facilitate displaying data.

Application serving layer 604 can be built using a web application layer (e.g. Ruby on Rails, Node.js/Express.js, etc.). The Application layer can either serve the UI or data APIs.

Static assets serving layer 606 can include various static assets that are kept in an object store and are served through a content delivery network

Job management component 608 can orchestrate data collection, server management, job scheduling and business status management.

Data collection system 610 can obtain digital data from data sources such as Google Analytics and store them in an object store. Data collection system 610 may not directly call the data source, but instead, all requests can be routed through adapter layer, preferable via REST APIs. This adapter layer can handle various functionalities like filters, multiple data sources, etc.

Data aggregation system 612 can be built using a cluster computing system (e.g. Spark, Apache Hadoop) to process the logs. A computing orchestration solution can be used to manage it at scale. The processed logs can be stored back in file system or object store. The analytics data can be stored in databases like MySQL, Cassandra, MongoDB, etc., ready to be used by the application layer.

Persona creator 614 can be built by processing the output of the data aggregation layer. A cluster computing system like Spark, Apache Hadoop can be used to process the logs.

Machine learning (ML) models 616 can be trained using public or private data. The models can be hosted as a microservice.

Content analyzer 618 can analyze the content viewed/interacted by the visitors (e.g. content on web pages visited).

Storage system 620 can use any database solution (like MySQL, MongoDB, Cassandra) for storing application data. Storage system 620 can use an in-memory storage solution for caching needs. A centralized caching solution available over TCP network can be shared by all layers.

All internal communication between rest endpoints also happens over https and is authenticated using signature which is encrypted.

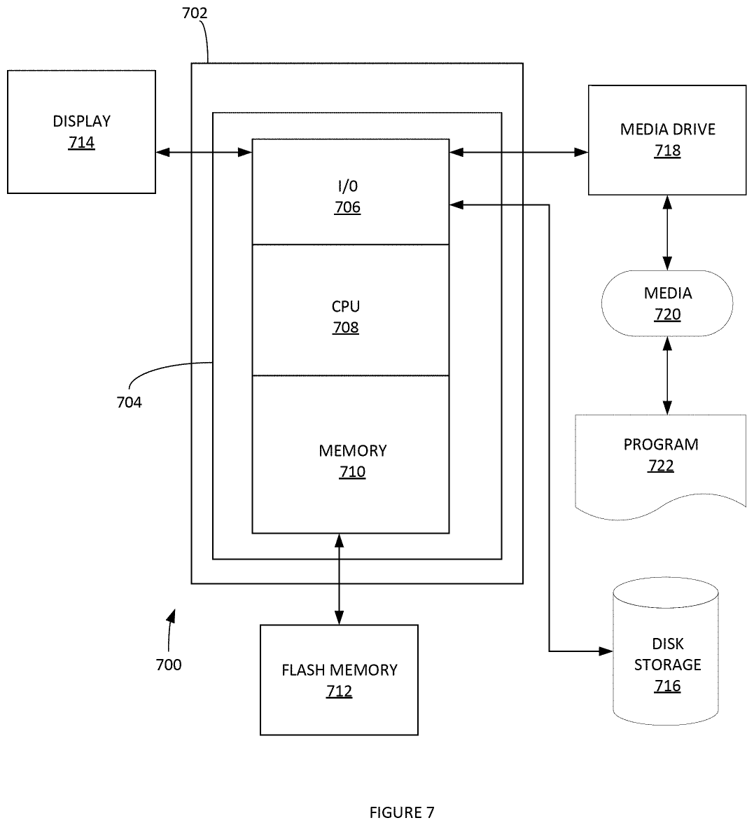

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

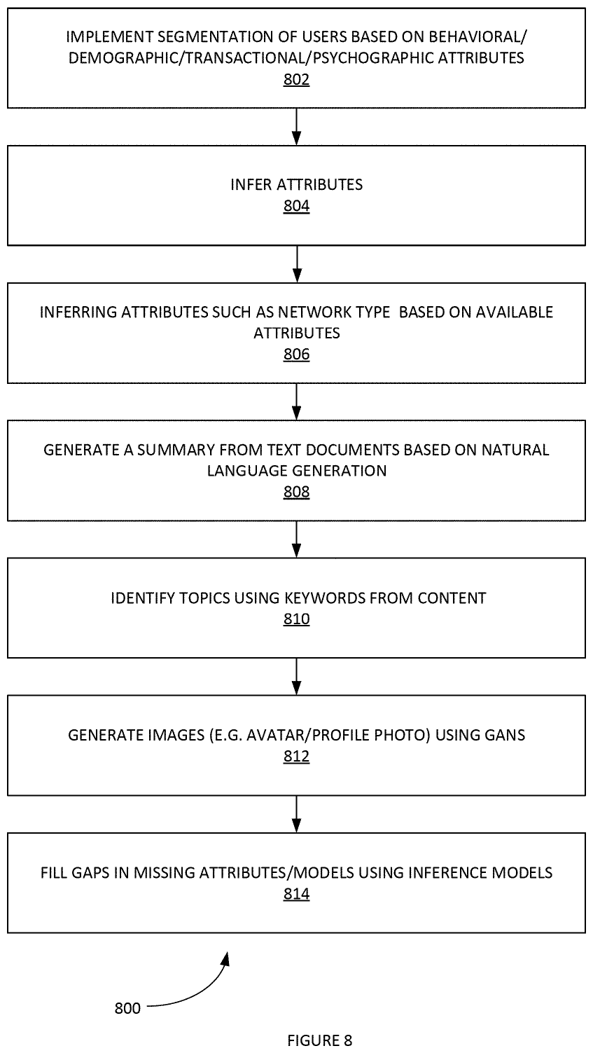

FIG. 8 illustrates an example process 800 for using AI/ML techniques to generate artificial personas, according to some embodiments. Specified AI/ML techniques are used in various steps when generating personas. In step 802, process 800 can implement segmentation of users based on behavioral/demographic/transactional/psychographic attributes. Segmentation can utilize, inter alia: K-Means clustering processes, hierarchical processes, DBScan clustering processes, etc. In step 804, process 800 can infer attributes. These can include, inter alia: business type (e.g. B2C/B2B), industry, job functions, based on content and/or engagement. Process 800 can use various methods for inference. These can include, inter alia: logistic regression, artificial neural network(s) using Tensor flow, etc.

In step 806, process 800 can inferring attributes such as network type (e.g. corporate network/Internet Service Provider) based on available attributes (e.g. network name). This step can use artificial neural network(s) based classification.

In step 808, process 800 can generating a summary from text documents based on natural language generation (e.g. using extractive text summarization techniques, etc.). In step 810, process 800 can identify topics and/or keywords from content (e.g. key phrase, word extraction based on occurrence, rarity, and volume, etc.).

In step 812, process 800 can generate images (e.g. avatar/profile photo) using Generative Adversarial Networks (GANs). This enables usage of AI generated images instead of stock photos/manually generated graphics.

In step 814, process 800 can fill gaps in missing attributes/models using inference models. Process 800 can use regression modelling for this step.

In one example, user personas can be used in conjunction with other data to build an ideal customer profile that can then be used to improve audience targeting and/or optimize content (e.g. in digital advertisement, etc.). This can be automated using an API system. APIs for generated personas can be used, for example, to keep the ideal customer profile(s) updated and to improve audience targeting, optimize/generate content and/or to personalize experiences via direct integrations with marketing/advertising tools/systems.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for managing an artificially-intelligent platform to generate personas automatically from digital data comprising:
obtaining an analytics data set;
augmenting the analytics data set with additional context information provided by augmentation data, wherein the augmentation data comprises specified a set of external data sources and data models;
determining, with a specified machine learning algorithm, a set of behavioral insights from the augmented analytics data set;
automatically grouping a set of users of a web-application or web site based on their behavior, demographics, history of transactions, and psychographics; and.
generating a persona for each of the segment associated with a user of the set of user, wherein a segment is a group based on a user behavior, a user demographic, a user transactional history, a user psychographic attribute.

2. The computerized method of claim 1 further comprising:
notifying an administrator when a change to a user persona occurs.

3. The computerized method of claim 1, wherein the analytics data set is obtained in an anonymized manner.

4. The computerized method of claim 1, wherein the augmentation data comprises a query analysis, an internet service provider, a connection speed, a device feature, and a display size.

5. The computerized method of claim 3, wherein the augmentation data comprises an analysis result.

6. The computerized method of claim 4, wherein the analysis result comprises a content analysis result or an action/event analysis.

7. The computerized method of claim 5 wherein the augmentation data comprises an urbanicity value, territory value, and a climate zone value.

8. The computerized method of claim 6, wherein a periodicity of the augmentation data is determined.

9. The computerized method of claim 7, wherein the periodicity comprises a specified weekday, a part of a day, a holiday, or a season.

10. The computerized method of claim 8, wherein the augmentation data comprises an identity information.

11. The computerized method of claim 9, wherein the identity information comprises an organization identity, an industry identity, a language identity, a translation identity, or an industry specific insight.

12. A computer system for managing an artificially-intelligent platform to generate personas automatically from digital data comprising:
a processor;
a memory containing instructions when executed on the processor, causes the processor to perform operations that:
obtain an analytics data set;
augment the analytics data set with additional context information provided by augmentation data, wherein the augmentation data comprises specified a set of external data sources and data models;
determine, with a specified machine learning algorithm, a set of behavioral insights from the augmented analytics data set;
automatically group a set of users of a web-application or web site based on their behavior, demographics, history of transactions, and psychographics; and.
generate a persona for each of the segment associated with a user of the set of user, wherein a segment is a group based on a user behavior, a user demographic, a user transactional history, a user psychographic attribute.

13. The computerized system of claim 12 further comprising:
notifying an administrator when a change to a user persona occurs.

14. The computerized system of claim 13, wherein the analytics data set is obtained in an anonymized manner.

15. The computerized method of claim 14, wherein the augmentation data comprises a query analysis, an internet service provider, a connection speed, a device feature, and a display size.

16. The computerized method of claim 15, wherein the augmentation data comprises an analysis result.

17. The method of claim 16, wherein the analysis result comprises a content analysis result or an action/event analysis.

18. The computerized system of claim 17 wherein the augmentation data comprises an urbanicity value, territory value, and a climate zone value.

19. The computerized system of claim 18, wherein a periodicity of the augmentation data is determined.

20. The computerized system of claim 19, wherein the periodicity comprises a specified weekday, a part of a day, a holiday, or a season.
